(19) United States
(12) Patent Application Publication
(10) Pub. No.: US 2025/0226784 A1
(43) Pub. Date: Jul. 10, 2025

(54) Thermal Battery Systems Comprising Emitter Units Equipped with Vapor Barriers

(71) Applicant: Fourth Power, Inc., Cambridge, MA (US)

(72) Inventors: Colin Clancy Kelsall, Cambridge, MA (US); Joe Patrinostro, Centerville, MA (US); Sandeep Pidaparti, Burlington, MA (US); Asegun Henry, Hyde Park, MA (US); John Lloyd, Portsmouth, RI (US); Tyler Young, Boston, MA (US); Mike Hvasta, Lawrence Township, NJ (US)

(21) Appl. No.: 19/014,502

(22) Filed: Jan. 9, 2025

Related U.S. Application Data
(60) Provisional application No. 63/619,157, filed on Jan. 9, 2024.

(51) Int. Cl. H02S 10/30; F28D 20/00

(52) U.S. Cl. CPC H02S 10/30; F28D 20/0034; F28D 2020/0047

(57) ABSTRACT

Described herein are thermal battery systems comprising emitter units equipped with vapor barriers. A vapor barrier prevents vapors (e.g., released by the emitter base during its heating) from reaching a TPV receiver when the TPV receiver is inserted inside the emitter unit. For example, the emitter base may comprise graphite, while the vapor barrier may comprise tungsten (at least on the TPV-facing surface). At the emitter unit's operating temperature of about 2000° C., the vapor pressure of tungsten is about 10,000 times lower than that of graphite (e.g., 10⁻⁷ Pa vs. 10⁻³ Pa). As such, the graphite emitter base may release appreciable amounts of vapors, which (if not blocked) can deposit on the TPV receiver (operating at less than 100° C. even when inside the emitter unit cavity). The vapor barrier blocks this vapor from reaching the cavity, while the emitter base provides mechanical support to the vapor barrier.

### CROSS-REFERENCE TO RELATED APPLICATIONS

This application claims the benefit under 35 U.S.C. § 119 (e) of U.S. Provisional Patent Application 63/619,157, entitled: “Deposition Prevention by Diffusion Barrier”, filed on 2024 Jan. 9, which is incorporated herein by reference in its entirety for all purposes.

### BACKGROUND

Thermophotovoltaics (TPV) are a class of heat engines that exploit the photovoltaic effect to convert radiant light from a heated body into electricity. Given sufficient reductions in cost and increases in power conversion efficiency, TPV generators could replace internal combustion or turbine engines in many applications. Similarly, TPV generators could recover industrial waste heat from certain processes to improve efficiency. These same advancements in TPV technology are enabling new applications such as energy storage.

It is often desirable to operate TPV systems or, more specifically, TPV emitters at very high temperatures, e.g., above 1500° C. or even above 1900° C. The total power radiated per unit area of a TPV emitter (“blackbody” in Stefan-Boltzmann Law) is proportional to the fourth power of the temperature P∝T⁴. Thus, higher temperatures lead to significantly higher radiative power. Higher temperatures also shift the peak of the emitted spectrum towards shorter wavelengths (per Wien's Displacement Law). This shift is more suitable for photovoltaic conversion if the bandgap of the TPV cells (on a TPV receiver) is appropriately matched thereby maximizing the absorption and conversion efficiency, which may be as high as 30% and even as high as 55%. Finally, some combustion, or industrial processes may generate high-temperature waste heat that can be harnessed using TPV systems, providing a practical application for energy recovery.

However, almost all materials (e.g., graphite) have a substantially high vapor pressure at these temperatures. Vaporized materials may then travel to colder parts of the TPV system (e.g., TPV receivers) and deposit on the surfaces of these cold parts. As such, vapor barriers are needed between high-temperature and low-temperature portions, e.g., which may be challenging considering the close proximity of these portions, coefficient of thermal expansions (CTEs), and other factors associated with the design and operation of TPV systems.

### SUMMARY

Described herein thermal battery systems comprising emitter units equipped with vapor barriers. A vapor barrier prevents vapors (e.g., released by the emitter base during its heating) from reaching a TPV receiver when the TPV receiver is inserted inside the emitter unit. For example, the emitter base may comprise graphite, while the vapor barrier may comprise tungsten (at least on the TPV-facing surface). At the emitter unit's operating temperature of about 2000° C., the vapor pressure of tungsten is about 10,000 times lower than that of graphite (e.g., 10⁻⁷ Pa vs. 10⁻³ Pa). As such, the graphite emitter base may release appreciable amounts of vapors, which (if not blocked) can deposit on the TPV receiver (operating at less than 100° C. even when inside the emitter unit cavity). The vapor barrier blocks this vapor from reaching the cavity, while the emitter base provides mechanical support to the vapor barrier.

Clause 1. An emitter unit for use in a thermal battery system, the emitter unit comprising: an emitter base; and a vapor barrier positioned on and supported by the emitter base and forms a vapor-isolated cavity of the emitter unit for receiving a TPV receiver while operating the thermal battery system, wherein: the vapor barrier comprises an exposed TPV-facing surface and a base-facing surface, opposite of the exposed TPV-facing surface, the base-facing surface is attached to and interfaces the emitter base and comprises carbon, and the exposed TPV-facing surface defines a boundary of the vapor-isolated cavity and faces the TPV receiver while the thermal battery system is operating.

Clause 2. The emitter unit of clause 1, wherein the base-facing surface comprises a carbide.

Clause 3. The emitter unit of clause 1, wherein the base-facing surface comprises a zirconium carbide.

Clause 4. The emitter unit of clause 1, wherein the emitter base is formed from a carbon-containing material.

Clause 5. The emitter unit of clause 4, wherein the carbon-containing material of the emitter base is selected from the group consisting of graphite, a carbon-fiber composite, silicon carbide, zirconium carbide, and titanium carbide.

Clause 6. The emitter unit of clause 4, wherein the carbon-containing material of the emitter base is graphite.

Clause 7. The emitter unit of clause 1, wherein the exposed TPV-facing surface and the base-facing surface have different compositions.

Clause 8. The emitter unit of clause 7, wherein the exposed TPV-facing surface comprises tungsten.

Clause 9. The emitter unit of clause 7, wherein the exposed TPV-facing surface consists essentially of tungsten.

Clause 10. The emitter unit of clause 7, wherein: the vapor barrier comprises a tungsten-metal layer and a carbide layer, the carbide layer is positioned between the emitter base and the tungsten-metal layer and forms the base-facing surface, and the tungsten-metal layer forms the exposed TPV-facing surface.

Clause 11. The emitter unit of clause 10, wherein: the tungsten-metal layer has a thickness of 50-200 micrometers, and the carbide layer has a thickness of 50-200 micrometers.

Clause 12. The emitter unit of clause 10, wherein the carbide layer comprises zirconium carbide.

Clause 13. The emitter unit of clause 1, wherein: the emitter base comprises a first base unit and a second base unit, the vapor barrier comprises a first barrier unit and a second barrier unit, the first barrier unit is supported on the first base unit, the second barrier unit is supported on the second base unit, a portion of the first barrier unit directly interfaces with a portion of the second barrier unit forming a barrier layer interface, extending away from the exposed TPV-facing surface, and an additional portion of the first barrier unit and an additional portion of the second barrier unit for the exposed TPV-facing surface.

Clause 14. The emitter unit of clause 13, wherein the barrier layer interface extends at an angle of 30-60° relative to each of the additional portion of the first barrier unit and the additional portion of the second barrier unit.

Clause 15. The emitter unit of clause 13, further comprises a fastener interconnecting the first base unit and the second base unit and applying pressure to the barrier layer interface.

Clause 16. The emitter unit of clause 15, wherein the fastener is formed from graphite.

Clause 17. The emitter unit of clause 1, further comprising a thermal insulation component surrounding the emitter base such that the emitter base is positioned between the thermal insulation component and the vapor barrier.

Clause 18. The emitter unit of clause 17, wherein: the thermal insulation component comprises an insulation opening, the emitter base comprises a base opening, aligned with the insulation opening and collectively forming an emitter opening, the emitter opening provides access to the vapor-isolated cavity, the vapor barrier comprises an opening-liner portion, extending between the exposed TPV-facing surface and an external surface of thermal insulation component and forming an internal wall of the emitter opening.

Clause 19. The emitter unit of clause 1, wherein the emitter base comprises a base fluid passage for circulating a molten metal through the emitter base to heat the emitter unit while operating the thermal battery system.

Clause 20. A thermal battery system comprising: a TPV receiver; and an emitter unit comprising an emitter base and a vapor barrier positioned on and supported by the emitter base and forms a vapor-isolated cavity of the emitter unit for receiving a TPV receiver while operating the thermal battery system, wherein: the vapor barrier comprises an exposed TPV-facing surface and a base-facing surface, opposite of the exposed TPV-facing surface, the base-facing surface is attached to and interfaces the emitter base and comprises carbon, and the exposed TPV-facing surface defines a boundary of the vapor-isolated cavity and faces the TPV receiver with the thermal battery system is operating.

Clause 21. The thermal battery system of clause 20, wherein: the TPV receiver comprises an external receiver surface defined by a receiver surface area, the exposed TPV-facing surface has a TPV-facing surface area, and a ratio of the TPV-facing surface area to the receiver surface area is at least 3.

Clause 22. The thermal battery system of clause 20, further comprising a storage unit and a piping infrastructure that fluidically couples the storage unit with the emitter unit.

Clause 23. The thermal battery system of clause 20, wherein the emitter base comprises a base fluid passage fluidically coupled with the storage unit.

Clause 24. A method of fabricating an emitter unit for use in a thermal battery system, the method comprising: providing an emitter base; and attaching a vapor barrier to the emitter base, wherein: the vapor barrier forms a vapor-isolated cavity of the emitter unit for receiving a TPV receiver while operating the thermal battery system, wherein: the vapor barrier comprises an exposed TPV-facing surface and a base-facing surface, opposite of the exposed TPV-facing surface, the base-facing surface is attached to and interfaces the emitter base and comprises a carbide, and the exposed TPV-facing surface defines a boundary of the vapor-isolated cavity and faces the TPV receiver with the thermal battery system is operating.

Clause 25. The method of clause 24, wherein attaching the vapor barrier to the emitter base comprises forming a carbide layer over the emitter base such that the carbide layer defines the base-facing surface of the vapor barrier.

Clause 26. The method of clause 25, wherein forming the carbide layer comprises: stacking a zirconium sheet over the emitter base thereby forming a stack, and heating the stack above the melting temperature of the zirconium sheet.

Clause 27. The method of clause 25, wherein forming the carbide layer comprises dipping the emitter base into a molten pool comprising zirconium.

Clause 28. The method of clause 24, wherein attaching the vapor barrier to the emitter base comprises conforming a tungsten sheet to the emitter base.

Clause 29. The method of clause 24, further comprising interconnecting multiple base units of the emitter base, such that each of the multiple base units has a corresponding one of barrier units that collectively form the vapor barrier.

Clause 30. The method of clause 29, wherein portions of the multiple base units interface each other along each edge of the vapor-isolated cavity.

Clause 31. A method of operating a thermal battery system comprising an emitter unit with an emitter base and a vapor barrier, the method comprising: circulating a molten metal through the emitter base, wherein: the emitter base is formed from graphite and comprises a base fluid passage, the molten metal is circulated through the base fluid passage, circulating the molten metal heats the emitter base to at least 0° C. thereby generating a vapor, and the vapor barrier forms a vapor-isolated cavity of the emitter unit and blocks the vapor from reaching the vapor-isolated cavity; and inserting a TPV receiver into the vapor-isolated cavity, wherein the vapor barrier produces a light emission that causes the TPV receiver to generate electricity upon reaching the TPV receiver.

Clause 32. The method of clause 31, wherein circulating the molten metal through the emitter base heats the emitter base to at least 1800° C.

Clause 33. The method of clause 31, further comprising preheating the emitter base above melting temperature of a material forming a molten metal.

Clause 34. The method of clause 31, wherein the molten metal comprises tin.

### BRIEF DESCRIPTION OF THE DRAWINGS

The included drawings are for illustrative purposes and serve only to provide examples of possible structures and operations for the disclosed inventive systems, apparatus, and methods. These drawings in no way limit any changes in form and detail that may be made by one skilled in the art without departing from the spirit and scope of the disclosed implementations.

FIG. 1 is a schematic illustration of a thermal battery system comprising an emitter unit fluidically coupled to a storage unit by piping infrastructure, in accordance with some examples.

FIG. 2A is a cross-sectional top view of a power block comprising an emitter unit and a TPV receiver inserted into the vapor-isolated cavity of the emitter unit during the operation of the thermal battery system, in accordance with some examples.

FIGS. 2B and 2C are side schematic views of different examples of the vapor barrier positioned on the emitter base.

FIG. 2D is a cross-sectional side view of a power block illustrating a thermal insulation component surrounding the emitter base with an emitter opening protruding through thermal insulation and emitter base such that the vapor barrier lines the sidewalls of the emitter opening, in accordance with some examples.

FIG. 2E is a cross-sectional side view of the power block in FIG. 2C with a TPV receiver positioned within a vapor-isolated cavity, in accordance with some examples.

FIG. 3A is an exploded view of a power block illustrating multiple parts of the emitter base and vapor barrier, interconnected together by fasteners to form a vapor-isolated cavity, in accordance with some examples.

FIG. 3B is a top schematic view of a vapor barrier illustrating various openings and cutouts, in accordance with some examples.

FIGS. 3C and 3D are side cross-sectional views of multiple base units (with corresponding barrier units supported on the base units) prior to and after assembly into an emitter unit, in accordance with some examples.

FIG. 4 is a cross-sectional top view of a power block illustrating nine vapor-isolated cavities arranged in a two-dimensional grid, in accordance with some examples.

FIG. 5 is a process flowchart corresponding to a method of fabricating an emitter unit for use in a thermal battery system, in accordance with some examples.

FIG. 6 is a process flowchart corresponding to a method of operating a thermal battery system comprising an emitter unit with an emitter base and a vapor barrier, in accordance with some examples.

FIG. 7 is a plot illustrating vapor pressures as a function of temperature for different materials.

### DETAILED DESCRIPTION

### Introduction

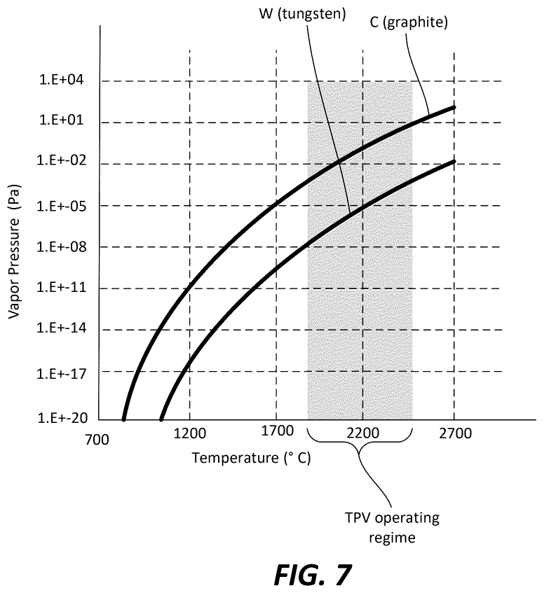

As noted above, thermal battery systems are designed to operate at high temperatures. At such high temperatures (e.g., 2000-2400° C.), the vapor pressure of almost all materials (e.g., used for various components of these systems) is appreciable (e.g., greater than 10⁻⁵ Pa). These vapors can flow to cold surfaces (e.g., TPV receivers operating at less than 100° C.) and deposit onto these cold surfaces (e.g., blocking the light from reaching TPV cells and reducing the efficiency of TPV receivers). Graphite, in particular, has an appreciable vapor pressure (e.g., as shown in FIG. 7 and described below) and can deposit on cold surfaces nearby, coating them enough to alter their optical properties within a few minutes. Tungsten, however, has a vapor pressure that is roughly 10,000 times lower than that of carbon at such high temperatures (e.g., as also shown in FIG. 7 and described below). As a result, tungsten sublimation is dramatically lower, when compared to carbon (which is the reason for using tungsten in incandescent light bulbs).

It has been found that positioning a tungsten layer over a surface of another material (e.g., graphite, used for emitter bases) can extend the operating lifetime of colder components (e.g., TPV receivers) from less than an hour to months or even years. Specifically, the surface of the emitter base, facing a TPV receiver, may be shielded using a vapor barrier (e.g., a tungsten layer). The vapor barrier is supported on the emitter base surface. In some examples, at least, the exposed TPV-facing surface of this vapor barrier may comprise tungsten (or consist essentially of tungsten). For example, a tungsten metal or a tungsten-based alloy may be used for this TPV-facing surface. In some examples (e.g., thermal battery systems operating at lower temperatures), this exposed TPV-facing surface of this vapor barrier may comprise a carbide or other refractory element or compound.

Since carbon and tungsten react at high temperatures (to form tungsten carbide-WC), a vapor barrier may include a carbide layer (e.g., zirconium carbide-ZrC) positioned between the graphite emitter base and the tungsten layer (forming the exposed TPV-facing surface). Carbon in this carbide layer is bound (to another metal/zirconium) and is not readily available to react with adjacent tungsten (unlike carbon in the graphite emitter base). In fact, zirconium carbide (ZrC) is particularly useful because it is more thermodynamically stable than tungsten carbide (WC) and does not react to form compounds with tungsten (W), at least below about 2800° C. Furthermore, at such high temperatures, the strength of tungsten (W) decreases, and various issues can arise with the tungsten layer being able to support its weight over long periods. To address this issue, a thin layer of tungsten foil is supported directly on the emitter base (e.g., conforming to its surface). In this respect, the emitter base (e.g., formed from graphite) may be used to provide mechanical structural support at high temperature, where tungsten's mechanical properties degrade (while graphite, carbides, and/or other refractory materials can exhibit high stiffness and creep resistance).

### Examples of TPV Systems

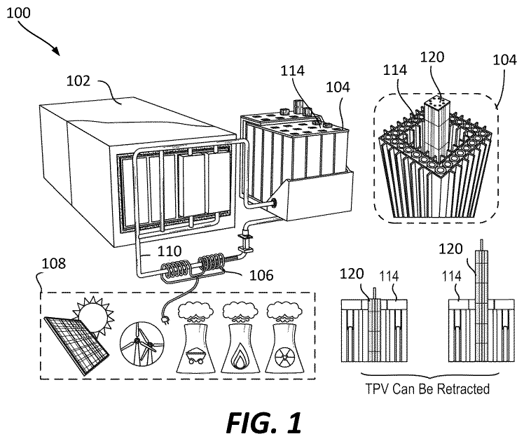

Various examples of TPV systems are within the scope, such as thermal battery systems, thermal generators, and the like. FIG. 1 is a schematic illustration of a thermal battery system 100 (interchangeably referred to herein as a thermal battery), in accordance with some examples. The thermal battery system 100 may comprise a storage unit 102, e.g., formed from a set of graphite blocks (however, other types of “thermal mass” capable of being stored at listed operating temperatures are also within the scope). The size and the number of these blocks determine, at least in part, the thermal capacity of the storage unit 102 and, more generally, of the thermal battery system 100. For example, the size of storage unit 102 can be 1,000-10,000 m³, while the size of each block may be 0.5-5 m³. The thermal battery system 100 may further comprise a power block 104 and a piping infrastructure 110 in which a liquid metal (e.g., tin-Sn) may flow between the storage unit 102 and the power block 104 for heat transfer. The thermal battery system 100 may include heating element 106 that may be configured to heat the liquid metal in the piping infrastructure 110. The heating element 106 may be powered by an energy source 108 (with various types of energy sources within the scope, e.g., solar, wind, hydroelectric, geothermal, biomass, nuclear, coal, natural gas, oil, tidal, wave, hydrogen, and biofuels).

A thermal battery system 100 exploits the fact that thermal radiation scales with absolute temperature to the fourth power (P∝T⁴), to achieve high power density and consequently low cost. In concept, a thermal battery system 100 may operate by taking in electricity (e.g., from renewables) to power heating elements 106 (e.g., resistive heaters) to the temperature of 1000-2800° C. or, more specifically, 1500-2500° C. The heating elements 106 convert the electricity into extremely high-temperature heat, which is then transferred to a power block 104 using a piping infrastructure 110 (e.g., a plumbing network made of graphite that carries liquid tin). The tin is mechanically pumped in the piping infrastructure 110 (forming a circulation loop). When the tin flows adjacent to the heating elements 106, the tin may nominally heat from the incoming lower temperature (e.g., 1900° C.) to an outgoing higher temperature (e.g., 2400° C.). At this higher temperature, the molten tin is then routed to storage unit 102 (e.g., a bank of energy storage blocks (ESBs) made of carbon or graphite). As the liquid metal passes through pipes situated in between gaps between the blocks, the ESBs are heated to the peak temperature to fully charge thermal battery system 100. The storage unit 102 (ESBs) are thermally insulated from the surroundings and can hold thermal energy for long periods (i.e., weeks to months) if needed. When electricity is desired back on the grid, the heating elements 106 are turned off, and the liquid metal is used to carry the sensible heat from the storage unit 102 (ESBs) over to a TPV power block 104. The TPV power block 104 comprises an emitter unit 114 with individual cavities, that have the liquid metal flowing through its walls, which keep the walls hot. The walls emit light that is then absorbed by the TPV receiver 120 or, more specifically, by the TPV cells and produces electricity (e.g., provided back to the grid).

Overall, the power block 104 is equipped with one or more emitter units 114 (e.g., arranged into a grid) with a TPV receiver 120 inserted into each emitter unit 114 during the operation of the thermal battery system 100. A combination of the emitter unit 114 and TPV receiver 120 is configured to convert thermal energy (provided by the storage unit 102) into electricity via a combination of heat radiation and photoelectric effects. As noted above, the emitter unit 114 may comprise a set of pipes for pumping a thermal fluid (e.g., molten tin) thereby heating the emitter unit 114 and producing the radiation, which is then converted by the TPV receiver 120 into electricity. In some examples, the TPV receiver 120 may be retracted (or removed) from the cavity in the emitter unit 114 and may be referred to as a TPV “stick” because of its extended shape.

Overall, a TPV receiver 120 is configured to operate proximate to an emitter unit 114 (i.e., positioned into the cavity of the emitter unit 114) while the emitter unit 114 is heated to a temperature of 1600-2500° C. or, more specifically, 1900-2500° C. It should be noted that other TPV applications do not involve such high temperatures and do not incur such large heat fluxes or penalties associated with inactive areas.

### Examples of Emitter Units

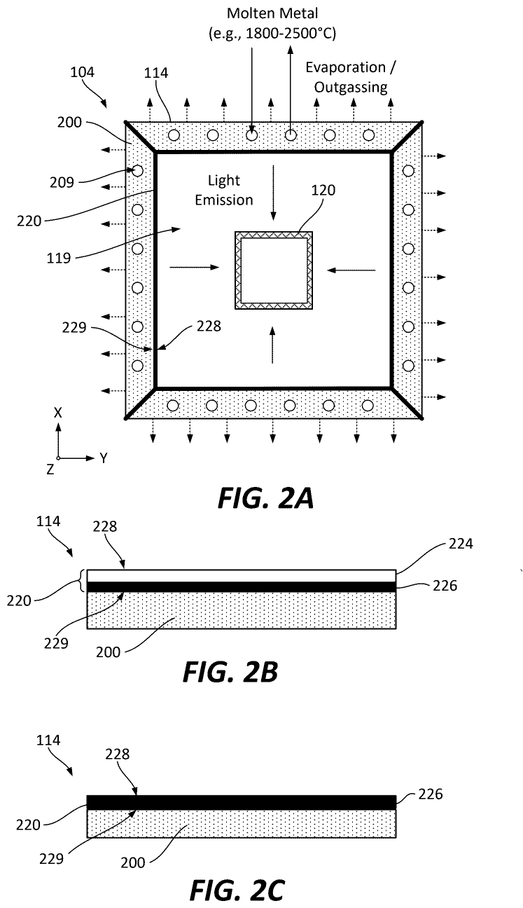

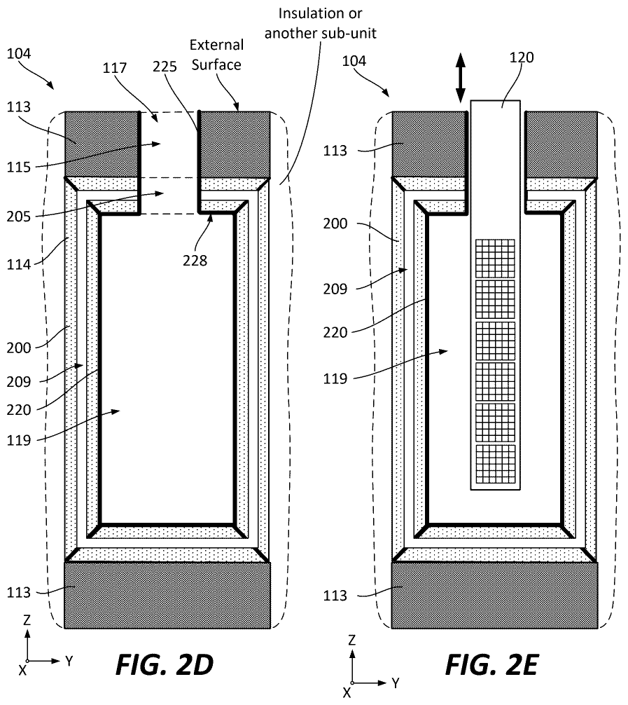

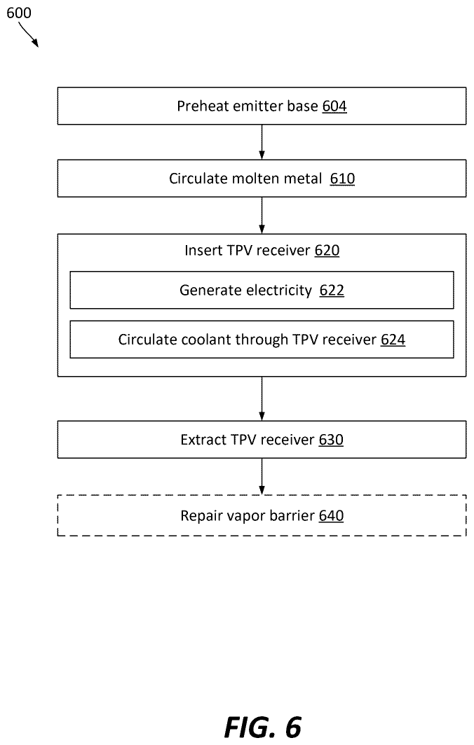

FIG. 2A is a cross-sectional top view of a power block 104 comprising an emitter unit 114 and a TPV receiver 120, in accordance with some examples. The TPV receiver 120 is not a part of the emitter unit 114 and is only inserted into the vapor-isolated cavity 119 of the emitter unit 114 during the operation of the power block 104 or, more generally, during the operation of the thermal battery system 100. Various aspects of a thermal battery system 100 are described above with reference to FIG. 1. Additional operating aspects of a thermal battery system 100 are described below with reference to FIG. 6.

Referring to FIG. 2A, an emitter unit 114 comprises an emitter base 200 and a vapor barrier 220. The emitter base 200 may be formed from a carbon-containing material, such as graphite, a carbon-fiber composite, silicon carbide, zirconium carbide, and titanium carbide. However, other types of materials are also within the scope. These materials depend on the operating temperatures of the emitter unit 114 and other factors.

The emitter base 200 may comprise a base fluid passage 209 for circulating a thermal fluid (e.g., molten metal or, more specifically, molten tin) through the emitter base 200 to heat the emitter unit 114 during the operation of the thermal battery system 100 as described below with reference to FIG. 6. Specifically, FIG. 2A illustrates a set of such passages evenly distributed around the perimeter of the emitter base 200. The number of such passages depends on the size of the emitter base 200 and the side of each passage. For example, the emitter base 200 may have a thickness/width (along the X-axis/along the Y-axis) of 200-500 millimeters with 3-15 fluid passages positioned on each of the four sides (shown in FIG. 2A) of the emitter base 200. It should be noted that the emitter base 200 may also comprise two additional sides (not visible in the cross-section of FIG. 2A, but are shown in FIGS. 2D and 2E). These two additional sides may be referred to as the top and bottom of the emitter base 200 and, in some examples, may be also equipped with fluid passages.

In some examples, each base fluid passage 209 has the largest cross-sectional dimension (e.g., a diameter) of 10-50 millimeters. The diameter depends on the thickness of the emitter-base walls, the length of each base fluid passage 209/the height of the emitter base 200, and the viscosity of the molten metal, that is flowed through the base fluid passage 209. For example, the dynamic viscosity of tin at 1000° C. is only 0.7 mPa·S (which, as a reference, is similar to the dynamic viscosity of water at 25° C.).

Referring to FIG. 2A, the vapor barrier 220 is positioned on and supported by the emitter base 200 and forms a vapor-isolated cavity 119 of the emitter unit 114. As noted above, the primary function of the vapor barrier 220 is to block the vapor generated (while heating the emitter base 200) from reaching a TPV receiver 120 (as well as other volatile components that may be present around the emitter base 200 but are desirable in the vapor-isolated cavity 119). Specifically, during the operation of the thermal battery system 100, the emitter base 200 is heated to a temperature of at least 1000° C., at least 1500° C., or even at least 2000° C. which results in appreciable evaporation of carbon from the emitter base 200 (referring to vapor pressure curves presented in FIG. 7). If the carbon vapor (and other volatiles) are allowed into the vapor-isolated cavity 119, the TPV receiver 120 will receive a deposit on its cold surface (with the TPV receiver 120 operating below 100° C.) and make the TPV receiver 120 inoperable. Specifically, the surface of the TPV receiver 120 needs to be free from any deposit to receive the light emitted by the emitter unit 114. The vapor barrier 220 blocks this vapor such that the vapor-isolated cavity 119 is substantially free from (and other volatiles) during the operation of the thermal battery system 100.

Referring to FIG. 2A, the vapor barrier 220 comprises an exposed TPV-facing surface 228 and a base-facing surface 229, opposite of the exposed TPV-facing surface 228. The distance between the exposed TPV-facing surface 228 and the base-facing surface 229 may be referred to as the thickness of the vapor barrier 220, which may be 50-500 micrometers or, more specifically, 100-400 micrometers. In some examples, this thickness may be formed by different materials, e.g., a carbide (e.g., zirconium carbide, tungsten carbide) at the base-facing surface 229 and a different carbide or a metal (e.g., tungsten metal) at the exposed TPV-facing surface 228. In other words, the exposed TPV-facing surface 228 and the base-facing surface 229 have different compositions. Specifically, in some examples, the exposed TPV-facing surface 228 comprises tungsten (e.g., a tungsten alloy, or commercially available pure tungsten metal). In more specific examples, the exposed TPV-facing surface 228 consists essentially of tungsten. For purposes of this disclosure, the term “consists essentially of” is defined as having an atomic concentration of at least 80%, at least 90%, or even at least 95%. In other examples, the exposed TPV-facing surface 228 has a concentration of tungsten (W) of at least 50% atomic, at least 60% atomic, and at least 70% atomic (e.g., tungsten can be in the form of an alloy, chemical compound, etc.)

In general, the exposed TPV-facing surface 228 may be formed from the material that has a vapor pressure of less than 10⁻² Pa or even less than 10⁻³ Pa at the maximum operating temperature of the emitter unit 114 or, more specifically, of the emitter base 200 and vapor barrier 220. In some examples, this maximum operating temperature is between 1800-2500° C. or, more specifically, 2000-2400° C. FIG. 7 is a plot illustrating vapor pressures as a function of temperature for different materials (e.g., tungsten and graphite). In general, the vapor pressure of zirconium carbide is 2 orders of magnitude lower than that of the graphite (for a given temperature of interest). Furthermore, the vapor pressure of tungsten is 2 orders of magnitude lower than that of zirconium carbide (for the same temperature).

It should be noted that carbon and tungsten chemically react (when in contact and heated). However, zirconium carbide and tungsten do not chemically react. Therefore, positioning a carbide layer 226 (e.g., zirconium carbide, tungsten carbide) between the tungsten-metal layer 224 and emitter base 200 helps to preserve the tungsten-metal layer 224 (rather than converting it into the tungsten carbide when the tungsten-metal layer 224 is initially placed in directed contact with the graphite of the emitter base 200). For purposes of this disclosure, the tungsten-metal layer 224 is defined as a layer that consists essentially of tungsten (e.g., having an atomic concentration of tungsten at least 80%, at least 90%, or even at least 95%).

Furthermore, zirconium carbide is less expensive than tungsten. As such, with the carbide layer 226, the tungsten-metal layer 224 can be made very thin, e.g., less than 200 micrometers, less than 150 micrometers, or even less than 100 micrometers. Furthermore, the small thickness of the tungsten-metal layer 224 helps to reduce the effects of the match in the coefficients of thermal expansion (CTEs) of the tungsten-metal layer 224, the carbide layer 226, and the emitter base 200. Finally, the small thickness of the tungsten-metal layer 224 helps with thermal transfer from the emitter base 200.

It should be noted that the emissivity of tungsten is only about 35% relative to the black body (vs. 80% emissivity of graphite). This reduction of the emissivity can be compensated by controlling the surface area ratios of various components, such as the exposed TPV-facing surface 228 and the TPV receiver 120. Specifically, the TPV receiver 120 comprises an external receiver surface defined by a receiver surface area. The exposed TPV-facing surface 228 has a TPV-facing surface area. In some examples, the ratio of the TPV-facing surface area to the receiver surface area is at least 2, at least 3, at least 4, or even at least 5. For example, this ratio may be 2-6 or, more specifically, 3-5. A larger ratio helps to compensate for the lower emissivity of tungsten as less light (emitted by the exposed TPV-facing surface 228) reaches the TPV receiver 120. The light effectively bounces within the vapor-isolated cavity 119 until it reaches the TPV receiver 120. However, a high ratio may not be practical as it requires a larger emitter unit 114, which is more difficult to make and operate.

Alternatively, the entire vapor barrier 220 is formed from the same material (e.g., zirconium carbide). For example, the emitter base 200 may be heated to temperatures less than 2400° C. or even less than 2200° C. during which the vapor pressure of the materials forming the vapor barrier 220 or, more specifically, its exposed TPV-facing surface 228 is sufficiently low to appreciably contaminate the vapor-isolated cavity 119. One such example is shown in FIG. 2C.

It should be noted that the TPV-facing surface 228 is not blocked by other layers and has a direct line of sight to the TPV receiver 120. Specifically, the exposed TPV-facing surface 228 defines a boundary of the vapor-isolated cavity 119 and faces the TPV receiver 120 during the operation of the thermal battery system 100.

As shown in FIGS. 2A-2C, the base-facing surface 229 is attached to and interfaces the emitter base 200. Regardless of the exposed TPV-facing surface 228, the base-facing surface 229 may comprise a carbide (e.g., zirconium carbide, titanium carbide, hafnium carbide, silicon carbide, tungsten carbide).

Referring to FIG. 2B, in some examples, the vapor barrier 220 comprises a tungsten-metal layer 224 and a carbide layer 226. The carbide layer 226 is positioned between the emitter base 200 and the tungsten-metal layer 224 and forms the base-facing surface 229. The tungsten-metal layer 224 forms the exposed TPV-facing surface 228.

In more specific examples, the tungsten-metal layer 224 has a thickness of 30-300 micrometers, 50-200 micrometers or, more specifically, 75-150 micrometers. In the same or other examples, the carbide layer 226 has a thickness of 5-200 micrometers, 10-150 micrometers or, more specifically, 20-100 micrometers.

Continuing with the example shown in FIG. 2B, the carbide layer 226 comprises zirconium carbide, which has a much lower vapor pressure than graphite (of the emitter base 200). Furthermore, zirconium carbide provides additional diffusion blocking, effectively operating as a secondary vapor barrier (in addition to the tungsten metal) or even the only vapor barrier (e.g., when the emitter base 200 is heated to temperatures below 1800° C., below 1500° C., or even less).

Referring to FIGS. 2D and 2E, in some examples, an emitter unit 114 further comprises a thermal insulation component 113 surrounding the emitter base 200 such that the emitter base 200 is positioned between thermal insulation component 113 and the vapor barrier 220. The thermal insulation component 113 may be sufficiently thick to ensure minimal heat dissipation while maintaining a heat gradient of over 1000° C., over 1500° C., or even 2000° C. The thermal insulation component 113 may be formed from various carbon-based materials.

Specifically and with reference to FIG. 2D, thermal insulation component 113 comprises an insulation opening 115. The emitter base 200 comprises a base opening 205, aligned with the insulation opening 115 and collectively forming an emitter opening 117. The emitter opening 117 provides access to the vapor-isolated cavity 119 such that a TPV receiver 120 can be inserted into and removed from the vapor-isolated cavity 119 through the emitter opening 117. The vapor barrier 220 comprises an opening-liner portion 225, extending between the exposed TPV-facing surface 228 and an external surface of thermal insulation component 113 and forming an internal wall of the emitter opening 117. Similar to other portions of the vapor barrier 220, the opening-liner portion 225 is supported by thermal insulation component 113 and the emitter base 200 that form the emitter opening 117.

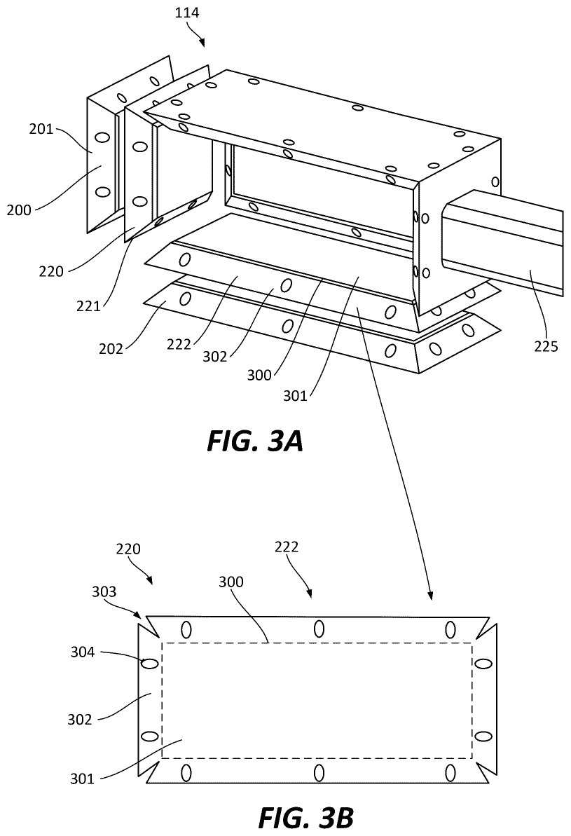

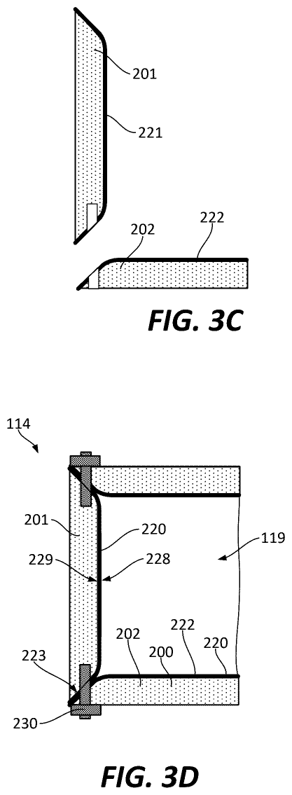

Referring to FIG. 3A, in some examples, the emitter base 200 comprises multiple base units that are assembled together to form a vapor-isolated cavity 119. For example, six base units may be used to form the vapor-isolated cavity 119 which has the shape of a rectangular prism. In general, the shape of the vapor-isolated cavity 119 is defined by the shape of the TPV receiver 120.

Each of the base units may have a corresponding barrier unit, one example of which is shown in FIG. 3B (i.e., a second barrier unit 222 from FIG. 3A). Specifically, the barrier unit is shown in a flat/unfolded format, e.g., as an intermediate step during the assembly of the base unit. Once formed and assembled, these barrier units collectively form the vapor barrier 220.

Referring to FIG. 3B, the barrier unit comprises a TPV-facing portion 301 and an interface-forming portion 302, separated by a bend line 300. During the fabrication of the barrier unit, the TPV-facing portion 301 may remain planar, while the interface-forming portion 302 may be bent out of plane (e.g., at an angle of 30-60° relative to the TPV-facing portion 301) along the bend line 300 (e.g., as shown in FIG. 3A). This bending allows for the interface-forming portions 302 of two adjacent barrier units to interface, e.g., as shown in FIGS. 3C and 3D. To assist with this bend, the barrier unit may have corner cuts 303. Furthermore, the barrier unit may have fastener openings 304 to allow for fasteners to protrude through the barrier unit, e.g., as shown in FIG. 3D.

Referring to FIGS. 3A, 3C, and 3D, in some examples, the emitter base 200 comprises a first base unit 201 and a second base unit 202. The vapor barrier 220 comprises a first barrier unit 221 and a second barrier unit 222. The first barrier unit 221 is supported on the first base unit 201. The second barrier unit 222 is supported on the second base unit 202.

Referring to FIG. 3D, when the emitter unit 114 is assembled, a portion of the first barrier unit 221 directly interfaces with a portion of the second barrier unit 222 forming a barrier layer interface 223. This barrier layer interface 223 extends away from the exposed TPV-facing surface 228. For the vapor-isolated cavity 119 having the shape of a rectangular prism, the emitter unit 114 may have 12 such barrier layer interfaces, one for each edge of the rectangular prism.

Referring to FIGS. 3A, 3C, and 3D, in some examples, wherein the barrier layer interface 223 extends at an angle of 30-60° relative to each of the additional portions of the first barrier unit 221 and the additional portion of the second barrier unit 222. Furthermore, an additional portion of the first barrier unit 221 and an additional portion of the second barrier unit 222 for the exposed TPV-facing surface 228. Referring to FIG. 3D, in some examples, an emitter unit 114 further comprises a fastener 230 interconnecting the first base unit 201 and the second base unit 202 and applying pressure to the barrier layer interface 223. In some examples, the fastener 230 is formed from graphite.

While the above description refers to the emitter unit 114, various features (e.g., a vapor barrier 220) may be also used on other components of a thermal battery system 100 such as a storage unit 102. For example, the graphite block of the storage unit 102 may have vapor barrier 220, e.g., to preserve the longevity of these blocks, use a TPV receiver 120 directly in the storage unit 102, and other reasons.

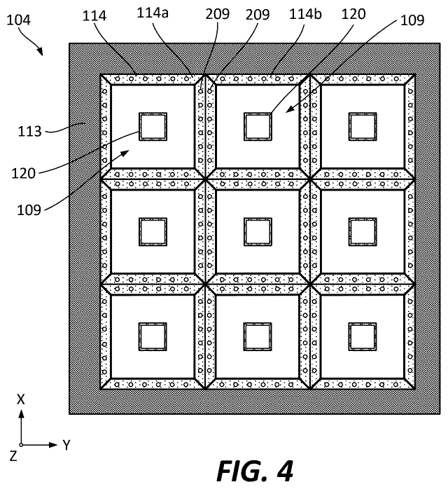

FIG. 4 is a cross-sectional top view of a power block 104 illustrating nine vapor-isolated cavities 109 arranged in a two-dimensional grid, in accordance with some examples. As described above, each nine vapor-isolated cavity 109 is formed by an emitter unit 114. These nine emitter units 114 may share the same thermal insulation component 113. Each emitter unit 114 may have its own dedicated set of base fluid passages 209 (e.g., as shown in FIG. 4). Alternatively, two adjacent emitter units 114 may share a subset of base fluid passages 209. More specifically, the same emitter base 200 may be positioned between two vapor-isolated cavities 109 with two vapor barriers 220, one positioned on each side of this shared emitter base 200.

### Methods of Fabricating Emitter Units

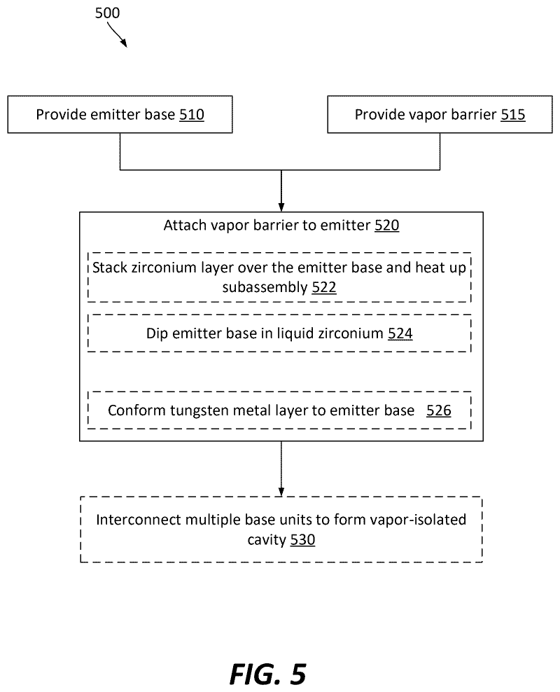

FIG. 5 illustrates a process flowchart of method 500 of fabricating an emitter unit 114 for use in a thermal battery system 100, in accordance with some examples. Various aspects of the emitter unit 114 and, more generally, of a thermal battery system 100 are described above.

In some examples, method 500 comprises (block 510) providing an emitter base 200 formed from graphite and comprising a base fluid passage 209. This base fluid passage 209 or, more specifically, a set of such passages is used for circulating a molten metal through the emitter base 200 to heat the emitter unit 114 during the operation of the thermal battery system 100 as further described below. During this base-providing operation, various features of the emitter base 200 may be formed, e.g., a base fluid passage 209, bevels, openings for fasteners, and the like.

In some examples, method 500 comprises (block 515) providing a vapor barrier 220 or, more specifically, a metal stock that later forms the vapor barrier 220 or at least a portion of the vapor barrier 220. For example, the metal stock may be a tungsten sheet having a thickness of 50-200 micrometers or, more specifically, 75-150 micrometers. Various features, e.g., corner cuts 303, fastener openings 304, and bends may be formed during this operation.

In some examples, method 500 comprises (block 520) attaching a vapor barrier 220 to the emitter base 200. The vapor barrier 220 comprises an exposed TPV-facing surface 228 and a base-facing surface 229, opposite of the exposed TPV-facing surface 228, e.g., as shown in FIGS. 2A-2C and described above. The base-facing surface 229 is attached to and interfaces the emitter base 200 and comprises a carbide. The exposed TPV-facing surface 228 defines a boundary of the vapor-isolated cavity 119 and faces the TPV receiver 120 during the operation of the thermal battery system 100.

In some examples, the barrier-attaching operation involves forming a carbide layer 226 over the emitter base 200 such that the carbide layer 226 defines the base-facing surface 229 of the vapor barrier 220. For example, a zirconium sheet may be (block 522) staked over the emitter base 200. This stack may be then heated above the melting temperature of zirconium (1855° C.) to allow zirconium to penetrate into the graphite of the emitter base 200 and form zirconium carbide (a carbide layer 226). It should be noted that a surface portion of the emitter base 200 is consumed during this operation to form the carbide layer 226. In a similar example, the emitter base 200 may be (block 524) dipped into a molten pool comprising zirconium (e.g., a zirconium-containing alloy), which provides a coating (e.g., a conformal coating) of the zirconium carbide over most (or all) of the emitter base surface. The coated surfaces may form the inside base fluid passages 209.

The barrier-attaching operation may also involve (block 526) conforming the metal stock (e.g., a tungsten sheet) to the emitter base 200. The metal stock may be pre-bent in an earlier operation and positioned over the emitter base 200 such that one side of the metal stock is in direct contact with the emitter base 200 or the carbide layer 226 formed over the emitter base 200. The emitter base 200 provides mechanical support to the metal stock. At this point, the vapor barrier 220 is effectively formed. It should be noted that a portion of the metal stock may be later converted into a carbide (e.g., tungsten carbide), which bonds the vapor barrier 220 to the emitter base 200. Specifically, some carbon may reach the metal stock and react with the metal during the operation of the thermal battery system 100 or, more specifically, when heating the emitter base 200 to temperatures greater than 1000° C., greater than 1500° C., or even greater than 2000° C. This metal carbide (formed from the metal stock during the system operation) may be the only carbide positioned between the remaining metal layer and the graphite of the emitter base 200 or it may be stacked with the previously formed carbide (e.g., forming a stack of a zirconium carbide layer and a tungsten carbide layer)—all of which can serve as layers to resist carbon transport.

In some examples, method 500 comprises (block 530) interconnecting multiple base units of the vapor barrier 220 to form a vapor-isolated cavity 119 of the emitter unit 114, e.g., as shown in FIGS. 3C-3D and using fasteners 230. This vapor-isolated cavity 119 is used for receiving a TPV receiver 120 during the operation of the thermal battery system 100, as further described below.

### Methods of Operating Thermal Battery Systems

FIG. 6 is a process flowchart corresponding to method 600 of operating a thermal battery system 100 comprising an emitter unit 114 with an emitter base 200 and a vapor barrier 220, in accordance with some examples. Various aspects of a thermal battery system 100 comprising an emitter unit 114 are described above.

Method 600 may commence with (block 604) preheating the emitter unit 114, e.g., to the temperature above the melting point of tin (232° C.). This operation can be achieved by circulating a liquid in the fluid channels and heating the liquid as would normally be done in the course of thermal battery operation.

Method 600 may proceed with (block 610) circulating a molten metal (molten tin) through the emitter base 200. For example, the molten metal may be circulated between the storage unit 102 and power block 104, which comprises one or more emitter units 114, each equipped with the emitter base 200. As noted above in the context of FIG. 4, in some examples, the same emitter base 200 may be shared by multiple emitter units 114. The molten metal may be heated in the storage unit 102 and cooled in the power block 104 (e.g., by producing the emission directed to the TPV receiver 120).

As noted above, the emitter base 200 is formed from graphite and comprises a base fluid passage 209. The molten metal is circulated through the base fluid passage 209. Circulating the molten metal heats the emitter base 200 to at least 1800° C., at least 2000° C., or even at least 2200° C. thereby generating a vapor. The vapor barrier 220 forms a vapor-isolated cavity 119 of the emitter unit 114 and blocks the vapor from reaching the vapor-isolated cavity 119; and

Method 600 may proceed with (block 620) inserting a TPV receiver 120 into the vapor-isolated cavity 119, wherein the vapor barrier 220 produces a light emission that causes the TPV receiver 120 to generate electricity upon reaching the TPV receiver 120. Specifically, this receiver-insertion operation may comprise (block 622) generating electricity (e.g., by converting the light adsorbed by the TPV receiver 120 into an electric current). Furthermore, this receiver-insertion operation may comprise (block 624) circulating a coolant through the TPV receiver 120, e.g., through various coolant channels provided within the base of the TPV receiver 120.

In some examples, method 600 further comprises (block 630) extracting the TPV receiver 120 from the vapor-isolated cavity 119. The insertion and extraction operations may be performed using an emitter opening 117 as described above with reference to FIGS. 2D and 2E.

In some examples, method 600 further comprises (block 640) repairing the vapor barrier 220, e.g., by positioning a tungsten metal patch over an opening in the vapor barrier 220. Once the emitter base 200 is heated, the surface of the tungsten metal patch (that faces the emitter base 200) may be converted to tungsten carbide thereby permanently bonding the tungsten metal patch to the emitter unit 114.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. An emitter unit for use in a thermal battery system, the emitter unit comprising:
an emitter base; and
a vapor barrier positioned on and supported by the emitter base and forms a vapor-isolated cavity of the emitter unit for receiving a TPV receiver while operating the thermal battery system, wherein:
the vapor barrier comprises an exposed TPV-facing surface and a base-facing surface, opposite of the exposed TPV-facing surface,
the base-facing surface is attached to and interfaces the emitter base and comprises carbon, and
the exposed TPV-facing surface defines a boundary of the vapor-isolated cavity and faces the TPV receiver while operating the thermal battery system.

2. The emitter unit of claim 1, wherein the base-facing surface comprises a carbide.

3. The emitter unit of claim 1, wherein the base-facing surface comprises a zirconium carbide.

4. The emitter unit of claim 1, wherein the emitter base is formed from a carbon-containing material.

5. The emitter unit of claim 4, wherein the carbon-containing material of the emitter base is selected from the group consisting of graphite, a carbon-fiber composite, silicon carbide, zirconium carbide, and titanium carbide.

6. The emitter unit of claim 4, wherein the carbon-containing material of the emitter base is graphite.

7. The emitter unit of claim 1, wherein the exposed TPV-facing surface and the base-facing surface have different compositions.

8. The emitter unit of claim 7, wherein the exposed TPV-facing surface comprises tungsten.

9. The emitter unit of claim 7, wherein the exposed TPV-facing surface consists essentially of tungsten.

10. The emitter unit of claim 7, wherein:
the vapor barrier comprises a tungsten-metal layer and a carbide layer,
the carbide layer is positioned between the emitter base and the tungsten-metal layer and forms the base-facing surface, and
the tungsten-metal layer forms the exposed TPV-facing surface.

11. The emitter unit of claim 10, wherein:
the tungsten-metal layer has a thickness of 50-200 micrometers, and
the carbide layer has a thickness of 50-200 micrometers.

12. The emitter unit of claim 10, wherein the carbide layer comprises zirconium carbide.

13. The emitter unit of claim 1, wherein:
the emitter base comprises a first base unit and a second base unit,
the vapor barrier comprises a first barrier unit and a second barrier unit,
the first barrier unit is supported by the first base unit,
the second barrier unit is supported by the second base unit,
a portion of the first barrier unit directly interfaces with a portion of the second barrier unit forming a barrier layer interface, extending away from the exposed TPV-facing surface, and
an additional portion of the first barrier unit and an additional portion of the second barrier unit for the exposed TPV-facing surface.

14. The emitter unit of claim 13, wherein the barrier layer interface extends at an angle of 30-60° relative to each of the additional portion of the first barrier unit and the additional portion of the second barrier unit.

15. The emitter unit of claim 13, further comprises a fastener interconnecting the first base unit and the second base unit and applying pressure to the barrier layer interface.

16. The emitter unit of claim 15, wherein the fastener is formed from graphite.

17. The emitter unit of claim 1, further comprising a thermal insulation component surrounding the emitter base such that the emitter base is positioned between the thermal insulation component and the vapor barrier.

18. The emitter unit of claim 17, wherein:
the thermal insulation component comprises an insulation opening,
the emitter base comprises a base opening, aligned with the insulation opening and collectively forms an emitter opening,
the emitter opening provides access to the vapor-isolated cavity,
the vapor barrier comprises an opening-liner portion, extending between the exposed TPV-facing surface and an external surface of the thermal insulation component and forming an internal wall of the emitter opening.

19. The emitter unit of claim 1, wherein the emitter base comprises a base fluid passage for circulating a molten metal through the emitter base to heat the emitter unit while operating the thermal battery system.

20. A method of fabricating an emitter unit for use in a thermal battery system, the method comprising:
providing an emitter base; and
attaching a vapor barrier to the emitter base, wherein:
the vapor barrier forms a vapor-isolated cavity of the emitter unit for receiving a TPV receiver while operating the thermal battery system, wherein:
the vapor barrier comprises an exposed TPV-facing surface and a base-facing surface, opposite of the exposed TPV-facing surface,
the base-facing surface is attached to and interfaces the emitter base and comprises a carbide, and
the exposed TPV-facing surface defines a boundary of the vapor-isolated cavity and faces the TPV receiver while the thermal battery system is operating.
